(19) United States
(12) Patent Application Publication
(10) Pub. No.: US 2025/0029616 A1
(43) Pub. Date: Jan. 23, 2025

(54) METHOD AND APPARATUS FOR REGISTERING AND UPDATING AUDIO INFORMATION ASSOCIATED WITH A USER

(71) Applicant: SAMSUNG ELECTRONICS CO., LTD., Suwon-si (KR)

(72) Inventors: Ruijie MENG, Beijing (CN); Lei YANG, Beijing (CN); Wei LIU, Beijing (CN); Xiaoyan LOU, Beijing (CN)

(73) Assignee: SAMSUNG ELECTRONICS CO., LTD., Suwon-si (KR)

(21) Appl. No.: 18/661,159

(22) Filed: May 10, 2024

Related U.S. Application Data
(63) Continuation of application No. PCT/KR2024/003777, filed on Mar. 26, 2024.

(30) Foreign Application Priority Data
Jul. 21, 2023 (CN) 202310906120.7

(51) Int. Cl. G10L 17/06; G10L 17/02; G10L 17/04; G10L 21/034; G10L 25/18; G10L 25/60

(52) U.S. Cl. CPC G10L 17/06; G10L 17/02; G10L 17/04; G10L 21/034; G10L 25/18; G10L 25/60

(57) ABSTRACT

According to an embodiment of the disclosure, a method may include determining registered audio information associated with a user based on a bone conduction (BC) signal. According to the embodiment of the disclosure, the method may include extracting a second audio signal corresponding to the user from a first audio signal based on the registered audio information associated with the user. According to the embodiment of the disclosure, the method may include processing the at least one from among the extracted second audio signal and a portion of the first audio signal which does not contain the second audio signal.

### CROSS-REFERENCE TO RELATED APPLICATIONS

This application is a bypass continuation of International Application No. PCT/KR2024/003777, filed on Mar. 26, 2024, in the Korean Intellectual Property Receiving Office, which claims priority to Chinese Patent Application No. 202310906120.7, filed on Jul. 21, 2023, in the China National Intellectual Property Administration, the disclosures of which are incorporated by reference herein in their entireties.

### BACKGROUND

### 1. Field

The disclosure relates to a field of audio processing and, in particular, to registering audio information associated with a user and updating the registered audio information.

### 2. Description of Related Art

Voice extraction, which may also be referred to as person-specific voice separation and voice filtering, is a technique for extracting a specific target voice from a mixed voice signal. This technique may be used in a variety of voice-related applications, such as a voice call, online conferencing, a voice command, a voice search, etc., to eliminate background noise, especially vocal noise. In order to improve an extraction quality of a target voice of a specific target speaker, some voice extraction techniques obtain registration information of the target voice in advance in order to perform extraction of the target voice. However, it may be difficult for existing voice extraction techniques to realize real-time voice extraction for any target speaker.

### SUMMARY

Provided is a method performed by an electronic apparatus, an electronic apparatus, and a storage medium to solve some or all of the above problems.

According to an embodiment of the disclosure, a method may include determining registered audio information associated with a user based on a bone conduction (BC) signal. According to the embodiment of the disclosure, the method may include extracting a second audio signal corresponding to the user from a first audio signal based on the registered audio information associated with the user. According to the embodiment of the disclosure, the method may include processing the at least one from among the extracted second audio signal and a portion of the first audio signal which does not contain the second audio signal.

According to an embodiment of the disclosure, an electronic apparatus comprising a memory, and at least one processor is provided. The one or more processor is configured to execute the instructions to select registered audio information associated with a user based on a bone conduction (BC) signal. The one or more processor is configured to execute the instructions to extract a second audio signal corresponding to the user from a first audio signal based on the registered audio information associated with the user. The one or more processor is configured to execute the instructions to process the at least one from among the extracted second audio signal and a portion of the first audio signal which does not contain the second audio signal.

According to an embodiment of the disclosure, a non-transitory computer-readable storage medium storing instructions is provided. The instructions may be executed by at least one processor, cause the at least one processor to determine registered audio information associated with a user based on a bone conduction (BC) signal. The instructions may be executed by at least one processor, cause the at least one processor to extract a second audio signal corresponding to the user from a first audio signal based on the registered audio information associated with the user. The instructions may be executed by at least one processor, cause the at least one processor to process the at least one from among the extracted second audio signal and a portion of the first audio signal which does not contain the second audio signal.

### BRIEF DESCRIPTION OF THE DRAWINGS

The above and other aspects will be more apparent from the following description of example embodiments in conjunction with the accompanying drawings, in which:

FIG. 1 illustrates a schematic diagram of a voice filter network structure according to example embodiments of the disclosure.

FIG. 2 illustrates a schematic diagram of a main flow of a voice extraction network according to example embodiments of the disclosure.

FIG. 3 illustrates a flowchart of a method performed by an electronic apparatus according to example embodiments of the disclosure.

FIG. 4 illustrates a difference between a bone conduction signal and an air conduction signal according to example embodiments of the disclosure.

FIG. 5 illustrates an internal block diagram of an extracted voice quality evaluation module according to example embodiments of the disclosure.

FIG. 6 illustrates a workflow diagram of an extracted voice quality evaluation according to example embodiments of the disclosure.

FIG. 7 illustrates a schematic diagram of offline training according to example embodiments of the disclosure.

FIG. 8 illustrates a diagram of a matching principle of a bone conduction signal and an extracted audio signal according to example embodiments of the disclosure.

FIG. 9 illustrates the sound and spectrum of an air conduction signal and a bone conduction signal according to example embodiments of the disclosure.

FIG. 10 illustrates an internal block diagram of a real-time imperceptible registration module according to example embodiments of the disclosure.

FIG. 11 illustrates a schematic diagram of generating updated registered audio information of a user according to example embodiments of the disclosure.

FIG. 12 illustrates a workflow diagram of updating registered audio information of a user according to example embodiments of the disclosure.

FIG. 13 illustrates a diagram of an encoder module according to example embodiments of the disclosure.

FIG. 14 illustrates a network flowchart of an encoder module according to example embodiments of the disclosure.

FIG. 15 illustrates a diagram of a decoder module according to example embodiments of the disclosure.

FIG. 16 illustrates a network flowchart of a decoder module according to example embodiments of the disclosure.

FIG. 17 illustrates a schematic block diagram of an electronic apparatus according to example embodiments of the disclosure.

FIG. 18 illustrates a block diagram of an electronic apparatus according to example embodiments of the disclosure.

### DETAILED DESCRIPTION

Hereinafter, example embodiments are described with reference to the accompanying drawings, in which like reference numerals are used to depict the same or similar elements, features, and structures. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

As used herein, the terms “1st” or “first” and “2nd” or “second” may use corresponding components regardless of importance or order and are used to distinguish a component from another component without limiting the components. It will be also understood that, although in example embodiments related to methods or flowcharts, a step or operation is described later than another step or operation, the step or operation may be performed earlier than the other step or operation unless the step or operation is described as being performed after the other step or operation. The example embodiments described herein do not represent all example embodiments that are consistent with the disclosure. Rather, the described example embodiments are examples of devices and methods that are consistent with some aspects of the disclosure, as detailed in the appended claims.

Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Extracting target voice from interfering sounds is a technique which may be used in many voice-related applications such as a voice call, automatic speech recognition (ASR), a voice search, voice conferencing, etc. According to embodiments of the present disclosure, a voice extraction may be performed using a voice filter, for which a user may pre-execute a voice registration in quiet environment to obtain the user's voice feature, and then the user's voice may be extracted from mixed audio.

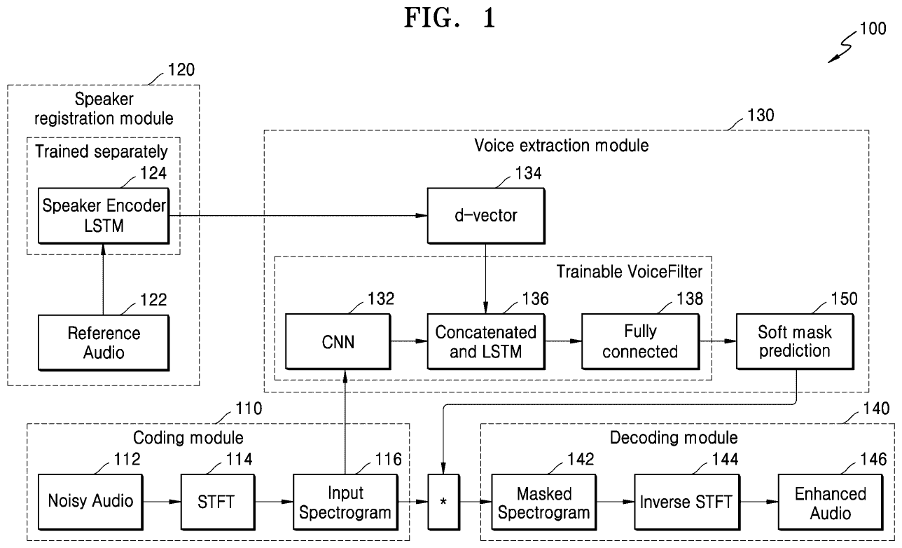

FIG. 1 illustrates a schematic diagram of a voice filter network structure. As shown in FIG. 1, a voice filter 100 may include a coding module 110, a speaker registration module 120, a voice extraction module 130, and a decoding module 140. The coding module 110 may perform a Short-time Fourier Transform (STFT) 114 on a input audio signal (e.g., noisy audio 112 in FIG. 1) and encode it to a high-dimensional feature vector to characterize the different dimensions of the voice (e.g., an input spectrogram 116 as shown in FIG. 1). The speaker registration module 120 may first perform encoding on the registered voice of a target speaker (e.g., reference audio 122 as shown in FIG. 1) by the speaker encoder Long Short-Term Memory Network (LSTM) 124 as shown in FIG. 1, and output a vector of speaker representation, which may be referred to as a d-vector 134. The voice extraction module 130 may input a feature of mixed voice (e.g., an input spectrogram 116 as shown in FIG. 1) and the d-vector 134, wherein the d-vector 134 is spliced together with the feature of the mixture voice at frame level after a convolutional neural network (CNN) module 132, and then perform a soft mask prediction 150, to output a target speaker mask which may represent a percentage of information corresponding to the target speaker has in the mixed audio. The decoding module 140 may use the target speaker mask to operate on the input spectrogram 116 to output a masked spectrogram 142, and may perform a short-time Fourier inverse transform (e.g., the inverse STFT 144 as shown in FIG. 1) on the masked spectrogram 142 to output an audio signal of the target speaker (e.g., enhanced audio 146 as shown in FIG. 1).

Some voice extraction techniques based on registration information associated with the target speaker may have a problem in that they may require the user to pre-register a voice, and the registered voice needs to be captured in relatively quiet environment. Another problem is that incorrect extraction results may be obtained when a user's voice feature changes. When the user's voice changes, the voice feature may be significantly different from the previously registered voice feature, which may lead to incorrect extraction results.

According to embodiments of the present disclosure, a quality of extracted audio may be evaluated using content matching of the extracted audio and a bone conduction (BC) signal. For example, the extracted audio and the BC signal may be classified by content at frame level and a quality score may be calculated with reference to a trained matching probability graphic (MPG). According to embodiments of the present disclosure, when the quality of the extracted audio is low, registered audio information associated with the user may be updated in real time through predicting a change of audio information with reference to a change of bone conduction information.

In the disclosure, the bone conduction (BC) signal is used. According to an embodiment, a stereo earphone, for example a true wireless stereo (TWS), may be equipped with a voice pickup unit (VPU) that may acquire the BC signal. The advantage of the BC signal may be that because other speakers' interference and noise cannot cause the user's skull to vibrate, only the user's own BC signal is collected by VPU, and it is aligned with the user's voice collected by the outer microphone at frame level.

According to embodiments, a method performed by an electronic apparatus and an electronic apparatus may evaluate the quality of the extracted audio based on the BC signal, and update the registered audio information associated with the user in real time through the BC signal when the evaluated quality of the extracted audio is low, which may allow an adaptive real-time registration of the user's voice. Therefore, the advance registration of the user's voice may not be required, which may improve the user experience. Further, a real-time updating of the registered audio information associated with the user may also be performed when the user's voice feature changes, which may improve the quality of the voice extraction and the naturalness of the voice.

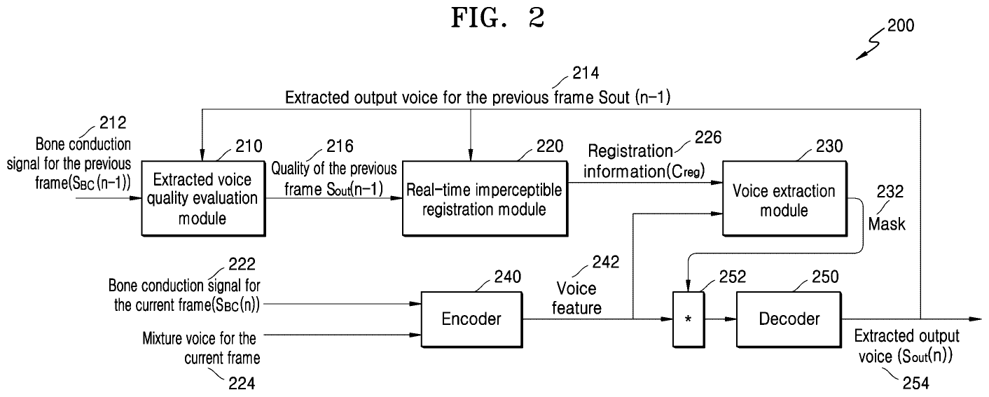

Examples of a method performed by an electronic apparatus and the electronic apparatus according to the disclosure are described below with reference to FIG. 2 to FIG. 18.

In embodiments of the disclosure, a target object may be, for example, a target speaker of audio to be extracted or a user of audio to be extracted (hereinafter referred to as a user).

FIG. 2 illustrates a schematic diagram of an example of a main flow of a voice extraction network according to example embodiments of the disclosure. The voice extraction network 200 may include an extracted voice quality evaluation module 210, a real-time imperceptible registration module 220, a voice extraction module 230, an encoder module 240, and a decoder module 250.

The extracted voice quality evaluation module 210 may evaluate a quality of the extracted audio with assistance of a BC signal. Inputs may include: a BC signal S_{BC}(n−1) 212 for a previous frame and an extracted output voice Sₒᵤₜ(n−1) 214 (which may also be referred to as an extracted voice, an extracted voice signal, an extracted audio, and an extracted audio signal) for the previous frame, and outputs may include: a quality of the previous frame Sₒᵤₜ(n−1) 216, e.g., a quality score.

The real-time imperceptible registration module 220 may perform real-time registration of audio information and/or update registered audio information. Inputs may include: a BC signal S_{BC}(n) 222 for a current frame, the quality of the previous frame Sₒᵤₜ(n−1) 216 and the previous frame Sₒᵤₜ(n−1) 214. Although the inputs of the real-time imperceptible registration module 220 in FIG. 2 include the previous frame Sₒᵤₜ(n−1) 214, the module 220 may use information from extracted audio Sₒᵤₜ 254 as the registered audio information associated with the user directly only in an initial state of use by the user, and subsequently, based on the quality of the extracted audio (e.g., the quality of the previous frame Sₒᵤₜ(n−1) 216), the registered audio information associated with the user is continuously Updated. Outputs of the real-time imperceptible registration module 220 may include: the registered audio information associated with the user C_{reg} 226 (which may also be referred to as current registered voice information C_{reg}).

The voice extraction module 230 may output a mask 232 (Mask) (e.g., a mask about the user) of a target object (e.g., a target speaker, a user) for extracting voice of the target object in mixed voice, wherein the mask of the target object 232 represents a percentage of information that the target speaker has in the mixed audio. Inputs may include: the registered audio information associated with the user C_{reg} 226, a feature of the mixed voice for the current frame 242 and a feature of the BC signal for the current frame 242, and outputs may include: the mask of the target object 232.

The encoder module 240 may perform a short-time Fourier transform on the input audio signal, and encode it into a high-dimensional feature vector 242, which may be used to characterize information in different dimensions of the voice. Inputs may include: the mixed voice for the current frame 224 and the BC signal S_{BC}(n) for the current frame 222, and outputs may include: the feature of the mixed voice for the current frame 242 and the feature of the BC signal for the current frame 242.

The decoder module 250 may decode the mixed voice using the mask of the target object, and output voice of the target object (e.g., extracted output voice 254). In embodiments, the operation of the module 252 marked with an “*” may be considered as part of the operation of the decoder module 250. Inputs may include: the feature of the mixed voice for the current frame 242 and the mask of the target object 232, and outputs may include: the extracted output voice Sₒᵤₜ(n) 254.

The example flow of the voice extraction network 200 described above may be applicable not only to the voice extraction, but also to a voice enhancement and a voice separation, without changing basic architecture thereof.

It should be understood that the schematic diagram of the main flow shown in FIG. 2 is only an example and some modules may be omitted or others may be added, and the disclosure is not limited thereto.

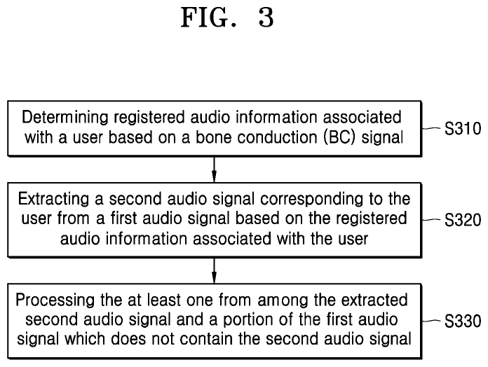

FIG. 3 illustrates a flowchart of a method performed by an electronic apparatus according to example embodiments of the disclosure.

Referring to FIG. 3, in step S310, registered audio information associated with a user is determined based on a BC signal.

The second audio signal may include the audio signal corresponding to the user.

According to embodiments of the disclosure, a quality of previously-extracted second audio signal is evaluated based on content of the previously-extracted second audio signal and the bone conduction (BC) signal; and the registered audio information associated with the user is determined based on the quality of the previously-extracted second audio signal.

For example, referring to FIG. 2, if the quality of the extracted audio signal Sₒᵤₜ(n−1) 216 (e.g., the previously-extracted second audio signal) is high, there may be no need to update the registered audio information associated with the user C_{reg} 226. However, if the quality of Sₒᵤₜ(n−1) 216 is low, this may mean that the user's user voice may change, and the registered audio information associated with the user may not correctly guide the voice extraction module 230 to work. Therefore, the quality of the extracted audio signal may first be evaluated.

According to embodiments of the disclosure, the previously-extracted second audio signal and the BC signal may be classified based on a voice feature; a matching probability between a category of the previously-extracted second audio signal and a category of the BC signal may be determined; and the quality of the previously-extracted second audio signal may be evaluated based on the matching probability.

In embodiments of the disclosure, a predetermined number of the extracted audio signals (e.g., the second audio signals previously-extracted) including the most recent extracted audio signal, and corresponding BC signals may be collected, each extracted audio signal and each BC signal may be classified respectively to obtain the predetermined number of air-bone conduction category pairs, matching may be performed on each air-bone conduction category pair to obtain the predetermined number of matching probabilities, and the quality of the extracted audio signal may be evaluated based on the predetermined number of matching probabilities.

In embodiments of the disclosure, the quality of the extracted audio may be evaluated using the BC signal of the target object, which may be detected by the VPU on the TWS. A potential disadvantage of the BC signal is that the user's voice propagates in the skull, unlike an air conduction (AC) signal (e.g., a signal of sound propagating in the air), and the BC signal may have a narrowband characteristic (e.g., only having frequency components less than 1 kHz).

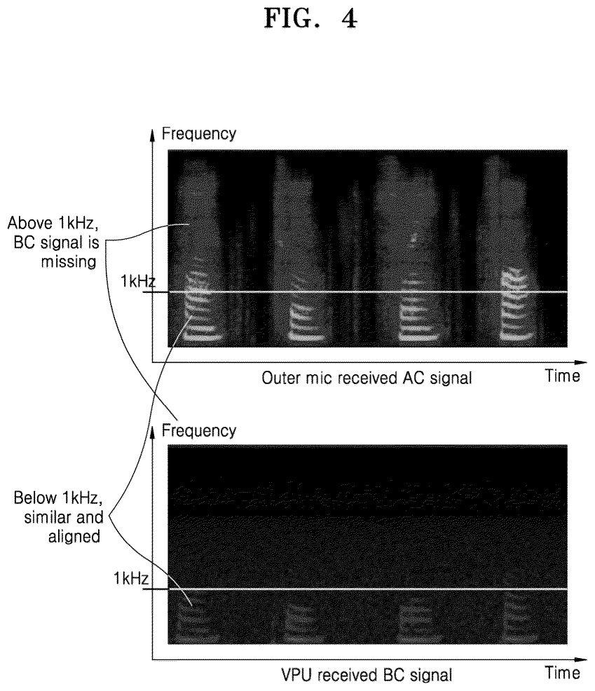

FIG. 4 illustrates a difference between a BC signal and an AC signal according to example embodiments of the disclosure. As shown in FIG. 4, the BC signal may lack a large amount of frequency information compared to the full bandwidth AC signal.

The BC signal may be free of interference and may be aligned with the voice signal of a target object (e.g., a target speaker, a user). Therefore, it may be used to evaluate the extracted audio signal through signal matching, but the BC signal may only have frequency information below 1 kHz, making it difficult or impossible to evaluate the high frequency quality of the extracted audio signal.

In embodiments of the disclosure, the quality may be evaluated by content matching of the extracted audio signal and the BC signal instead of using frequency-dependent signal matching. Content matching here may refer to content matching at a frame level. Content matching may be achieved by classifying the extracted audio signal and the BC signal into phoneme-like categories based on the voice feature. A phoneme may refer to the smallest unit of speech in language that may distinguish meaning, such as [ai] and [æ]. A phoneme-like category may refer to classification of speech features that is similar to standard phoneme classification but not in a one-to-one correspondence. For example, it may not be necessary to decode specific phoneme information, and so no additional steps may be used to obtain specific phoneme information. Phoneme-like classification results may be sufficient, according to embodiments.

According to embodiments of the disclosure, the previously-extracted second audio signal and the BC signal may be classified respectively, using a pre-trained classifier, and a matching probability graphic obtained by pre-training may be looked up for the category of the previously-extracted second audio signal and the category of the BC signal to determine the matching probability.

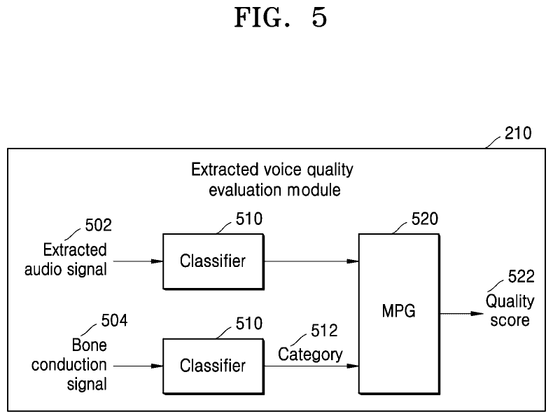

The operations of FIG. 5 through FIG. 8 below may correspond to the operations associated with the extracted voice quality evaluation module 210 of FIG. 2.

FIG. 5 illustrates an internal block diagram of an extracted voice quality evaluation module 210 according to example embodiments of the disclosure. Referring to FIG. 5, in the extracted voice quality evaluation module 210, a predetermined number (e.g., N frames, wherein N is a positive integer) of extracted audio signals 502 (e.g., second audio signals previously-extracted) may be collected through a cache, and the predetermined number (e.g., N frames) of BC signals of the target object 504 may also be collected through a cache. The predetermined number of extracted audio signals 502 may include the most recent extracted audio signal, e.g., Sₒᵤₜ(n−1) 214 in FIG. 2, and accordingly, the predetermined number of BC signals 504 may include the most recent BC signal, e.g., S_{BC}(n−1) 212 in FIG. 2. After the extracted audio signal and the BC signal of each frame are respectively input into the same classifier 510 for classification, the total predetermined number (e.g., N) of air-bone conduction category pairs 512 are obtained, and then the matching probability graphic is looked up for each air-bone conduction category pair of each frame to obtain the total predetermined number of matching probabilities, and a quality score 522 (e.g., an average of the matching probabilities) may be calculated based on the matching probabilities and output, for example by the MPG 520.

It should be understood that the internal block diagram of the extracted voice quality evaluation module 210 here is only an example and some modules may be omitted or others may be added, and the disclosure is not limited thereto.

As discussed above, the BC signal and the extracted audio signal may be classified:

The classifier 510 may be obtained by training the voice feature offline. When extracted voice quality evaluation is performed online, the input BC signal 504 and extracted audio signal 502 may be classified using the offline trained classifier 510, respectively. The categories 512 of the BC signal and the extracted audio signal may be obtained respectively based on the distance between classified results and category centers of existing categories, which may be processed frame-by-frame, and the output is the air-bone-conduction category pair for each frame.

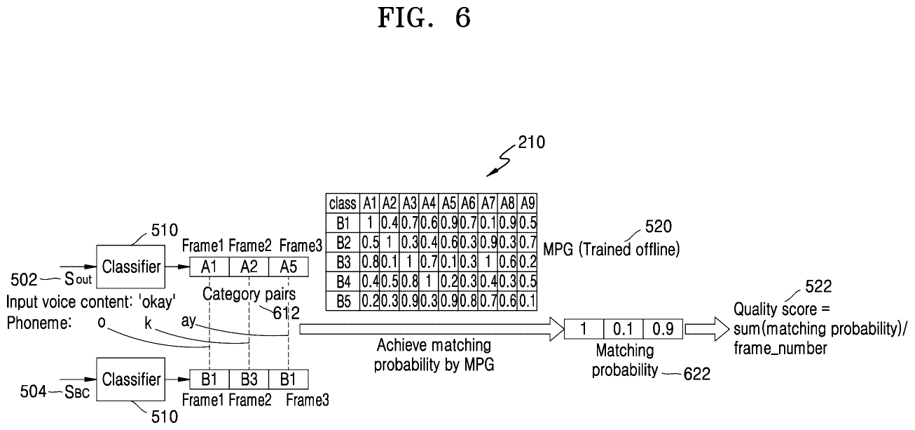

FIG. 6 illustrates a workflow diagram of an extracted voice quality evaluation according to example embodiments of the disclosure.

Referring to FIG. 6, input voice content (e.g., “Okay”) may be divided into three categories 612 according to the extracted audio signals 502 and the BC signals 504 after classification, and each category corresponds to one type of phoneme-like content information. For example, corresponding to three frames of extracted audio signals and BC signals, three category pairs may be output, such as (A1, B1), (A2, B3) and (A5, B1) respectively.

The matching probability 622 of the extracted audio signal and the BC signal may be evaluated using the matching probability graphic (MPG) 520.

The MPG 520 may be obtained by offline training, the classifier 510 may classify the BC signal 504 and the extracted audio signal 502 respectively to obtain one category pair, and all category pairs 612 obtained according to training data form the MPG 520, which represents correspondence (e.g., similarity) between the category 612 of the extracted audio signal and the category of the BC signal. For example, the matching probabilities obtained by looking up the MPG 520 for the three category pairs 612 described above may be 1, 0.1, and 0.9, respectively.

The quality of extracted audio may be evaluated based on the matching probability.

For example, an average of the matching probabilities (e.g., similarities) of the extracted audio signals and the BC signals for all frames may be counted as a quality evaluation result (e.g., a quality score 522) of the extracted audio, as shown in Equation 1 below.

$$score = \frac{Σ {s}_{i}}{N} \qquad ( Equation 1 )$$

In Equation 1, sᵢ may denote the matching probability of the extracted audio signal and the BC signal for the ith frame, and N may denote the total number of frames. For example, the quality score 522 obtained based on the above three matching probabilities 1, 0.1 and 0.9 may be 0.67.

It should be understood that the use of the average of the matching probabilities as the quality evaluation result here is only an example, and a sum of all frames, for example, may also be used, and the disclosure is not limited thereto.

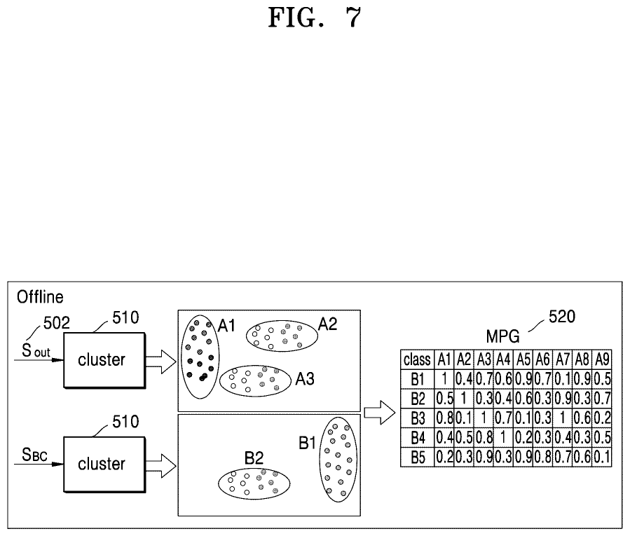

FIG. 7 illustrates a schematic diagram of offline training according to example embodiments of the disclosure. In FIG. 7, in the operation of extracted voice quality evaluation, the classifier 510 may be trained offline by clustering voice features offline, and the MPG 520 may be a matching probability table obtained by the offline training. The classifier 510 here may be, for example, but is not limited to, a neural network for performing (or trained to perform) the classification task, such as a convolutional neural network plus full connection (CNN+FC).

In an embodiment, due to the incomplete vowel of the BC signal, similar sounds may be classified into one category, and thus one category of the BC signal may correspond to a plurality of categories of the extracted audio signal.

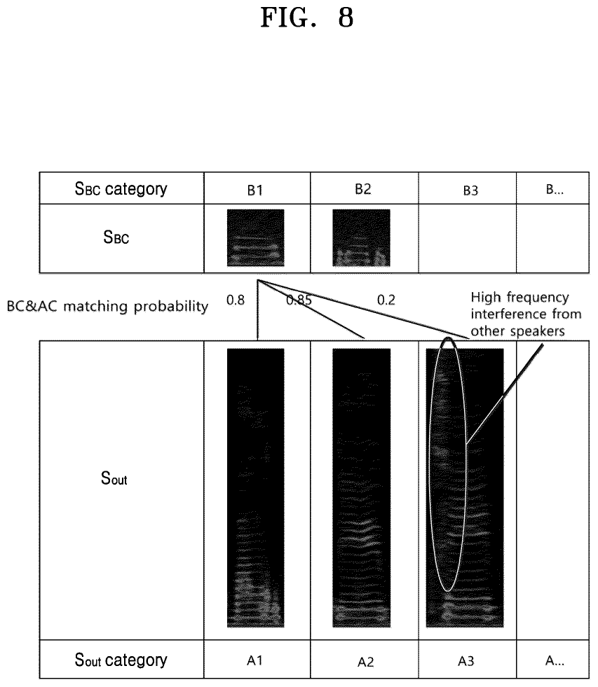

FIG. 8 illustrates a diagram of a matching principle of a BC signal and an extracted audio signal according to example embodiments of the disclosure. Referring to FIG. 8, Ai denotes the category of the extracted audio signal (e.g., the extracted voice signal) Sₒᵤₜ for the ith frame and B1 denotes the category of the BC signal S_{BC} for the ith frame. It may be seen that category B1 matches with categories A1 and A2 with probability 0.8 and 0.85. A1 and A2 may be pronounced similarly, so they may both point to the same B1 category. The signal in category A3 may be assumed to be in category A2, but may have high-frequency interferences from other speakers, so the classifier may classify this signal into category A3. The probability of B1 matching with A3 may be only 0.2, which may mean that the signal in B1 may do not match with the signal in A3.

The problem of frequency limitation of the BC signal may be solved through the above extracted voice quality evaluation method and the extracted audio signal may be evaluated through the BC signal. Content matching may work normally in daily communication scenes, and also in scenes where the content is highly consistent such as chorus and reading aloud. This is because the probability of content being exactly the same may be low based on frame-level content matching.

According to embodiments of the disclosure, determining the registered audio information associated with the user based on the quality of the previously-extracted second audio signal may include: determining a need to update the registered audio information associated with the user based on the quality of the previously-extracted second audio signal; determining a feature change trend of BC registration information; predicting registered audio information from an AC signal as the registered audio information associated with the user based on the feature change trend of the BC registration information.

According to embodiments of the disclosure, the registered audio information associated with the user may be updated based on determining that the quality of the previously-extracted second audio signal does not satisfy a predetermined condition; and the registered audio information associated with the user may be not updated based on determining that the quality of the previously-extracted second audio signal satisfies the predetermined condition.

The first audio signal may include the mixed voice.

In embodiments of the disclosure, the registered audio information associated with the user may be obtained based on a predetermined duration of voice of the target object (e.g., the user) extracted from the first audio signal (e.g., the mixed voice). Specifically, information from the predetermined duration of voice of the user extracted from the mixed voice may be used as the registered audio information associated with the user in an initial state. In the initial state of use by a user (e.g., the initial state in which the voice extraction network shown in FIG. 2 is used for the first time or again, or the initial state in which the voice extraction network is used after a change of a user), the information from the predetermined duration (e.g., 1 frame) of the voice of the user extracted from the mixed voice may be used as the registered audio information associated with the user, and the registered audio information associated with the user in the initial state may be utilized to begin extracting the user's voice in the mixed voice.

In an embodiment of the disclosure, the quality of the extracted audio is evaluated at this time, the quality of the extracted audio may not be high, and the quality of the extracted audio may be improved subsequently by updating the registered audio information associated with the user. Therefore, on one hand, in the initial state of use by the user, the information of the extracted audio may be directly used as the registered audio information associated with the user; on the other hand, when the quality of the extracted audio is evaluated to be low subsequently, the information from the extracted audio as the registered audio information associated with the user in the initial state may undergo constant updating to obtain the updated registered audio information associated with the user.

Here, examples of the predetermined duration include, but are not limited to, a duration of 1 frame. In embodiments of the disclosure, the information from the extracted audio may be used as the real-time registered audio information associated with the user without requiring the user to register the voice in advance, which may eliminate inconvenience of registration in advance for the user and improves the user experience.

Referring again to FIG. 2, if the quality of the extracted audio signal Sₒᵤₜ(n−1) 216 satisfies a predetermined condition, it may be determined that there is no need to update the registered audio information 226 associated with the user, and the previous registered audio information associated with the user may continue to be used, but if the quality of Sₒᵤₜ(n−1) 216 does not satisfy the predetermined condition, this means that the user's voice may have changed, and the registered audio information associated with the user may not be appropriate to correctly guide the voice extraction module 230 to work, and it therefore may be determined that the registered audio information 226 associated with the user needs to be updated. The predetermined condition here may be, for example, but is not limited to, the quality score being greater than a predetermined score.

According to embodiments of the disclosure, the feature change trend of the BC registration information may be determined based on historical BC registration information and current BC registration information, using a first artificial intelligence (AI) model. According to embodiments of the disclosure, a feature change trend of the registered audio information from the AC signal may be determined based on the feature change trend of the BC registration information, using a second AI model. According to embodiments of the disclosure, the registered audio information from the AC signal may be obtained as the registered audio information associated with the user based on the feature change trend of the registered audio information from the AC signal and historical registered audio information from the AC signal, using a third AI model.

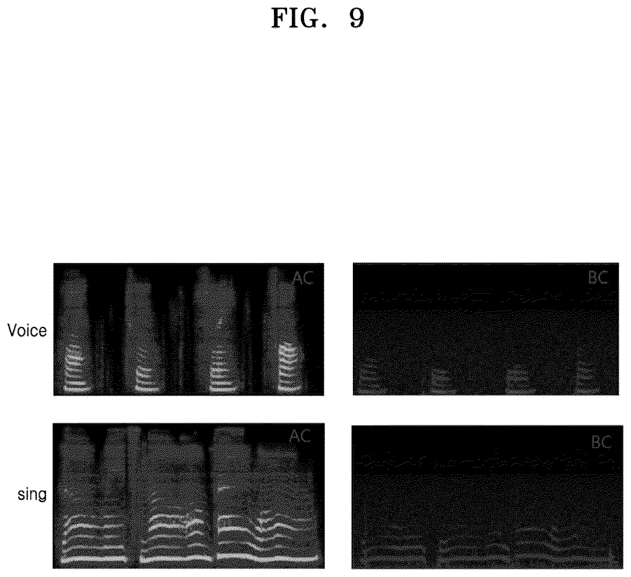

FIG. 9 illustrates the sound and spectrum of an AC signal and a BC signal. Referring to FIG. 9, a change in the BC signal and a change in the AC signal from hearing are related and regular when the user's voice changes. Moreover, the BC signal is reliable for the current speaker characteristics because it is only relevant to the user. A change feature (e.g., a feature change trend) of the user's AC signal (e.g., the audio signal) is predicted and generated based on learning a change feature (e.g., a feature change trend) of the user's BC signal to adaptively update the registered audio information associated with the user in real time.

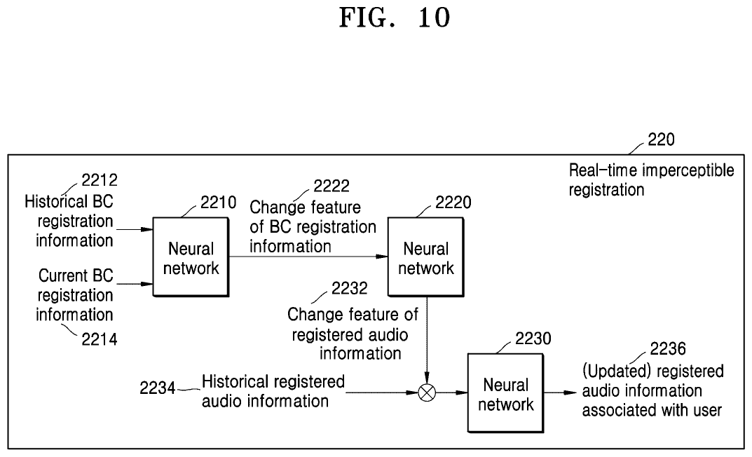

The operations of FIG. 10 through FIG. 12 below may correspond to operations associated with the real-time imperceptible registration module 220 of FIG. 2.

FIG. 10 illustrates an internal block diagram of a real-time imperceptible registration module 220 according to example embodiments of the disclosure.

Referring to FIG. 10, internal inputs of the real-time imperceptible registration module 220 when performing the update operation may include: historical BC registration information 2212 (which may also be referred to as historical BC information), current BC registration information 2214 (which may also be referred to as current BC information) and historical registered audio information from the AC signal 2234 (which may also be abbreviated as historical registered audio information), and outputs may include: updated registered audio information associated with the user 2236, wherein the historical BC registration information 2212 and the historical registered audio information 2234 may be considered to be information collected within the real-time imperceptible registration module 220.

Referring to FIG. 10, three AI models may be included in the real-time imperceptible registration module 220. In embodiments, inputs of the first AI model 2210 may include: the historical BC registration information 2212 and the current BC registration information 2214, and outputs may include: a change feature of the BC registration information 2222 (e.g., a feature change trend of the BC registration information).

In embodiments, inputs of the second AI model 2220 may include: the change feature of the BC registration information 2222, and outputs may include: a change feature of the registered audio information from the AC signal 2232 (hereinafter also abbreviated as a change feature of the registered audio information, e.g., a feature change trend of the registered audio information from the AC signal).

In embodiments, inputs of the third AI model 2230 may include: the change feature of the registered audio information 2232 and the historical registered audio information 2234, and outputs may include the registered audio information from the AC signal as the (updated) registered audio information associated with the user 2236. The registered audio information associated with the user 2236 may be information characterizing the registered audio signal (e.g., a registered voice signal) of the user. In addition, the change feature of the registered audio information 2232 and the historical registered audio information 2234 may be input into the third AI model 2230 after being spliced.

The BC registration information (including the historical BC registration information 2212 and the current BC registration information 2214) here may be considered to be the information obtained after feature processing (e.g., feature extraction) on the basis of the BC signal (correspondingly including the historical BC signal and the current BC signal (e.g., S_{BC}(n))), and the BC registration information 2214 may be the information characterizing the BC signal. The historical registered audio information 2234 here may be considered to be information obtained after feature processing (e.g., feature extraction) on the basis of the historical registered audio signal, and the historical registered audio information 2234 may be the information characterizing the historical registered audio signal. In addition, the historical BC registration information 2212 may correspond to the historical registered audio information 2234, and specifically, a time period of a selected segment of the historical BC signal may correspond to that of the historical registered audio signal. Accordingly, one or more feature processing modules may be incorporated prior to the first AI model 2210 to convert the BC signal to corresponding BC registration information and/or to convert the audio signal to corresponding audio information, or the one or more feature processing modules may be part of the above-described AI models, and thus, the inputs to the AI models may be the corresponding BC signal (e.g., S_{BC}(n)) or the audio signal.

It should be understood that the internal block diagram of the real-time imperceptible registration module 220 here is an example only and that some modules may be omitted or others may be added, and the disclosure is not limited thereto.

The AI model may be obtained through training. Here, “obtained through training” means training a basic AI model with a plurality of training data through a training algorithm, thereby obtaining a predefined operating rule or AI model, the operating rule or A1 model being configured to perform a desired feature (or purpose). One or more of the first A1 model 2210, the second AI model 2220 and the third AI model 2230 here may be, for example, a neural network model (an attention model), but the disclosure is not limited thereto, and one or more of the AI models may also be a neural network model including a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network, or other AI models.

According to embodiments of the disclosure, the historical registered audio information from the AC signal includes the registered audio information corresponding to the previously-extracted second audio signal evaluated to be of a highest quality, and wherein the historical BC registered information corresponds to the historical registered audio information from the AC signal.

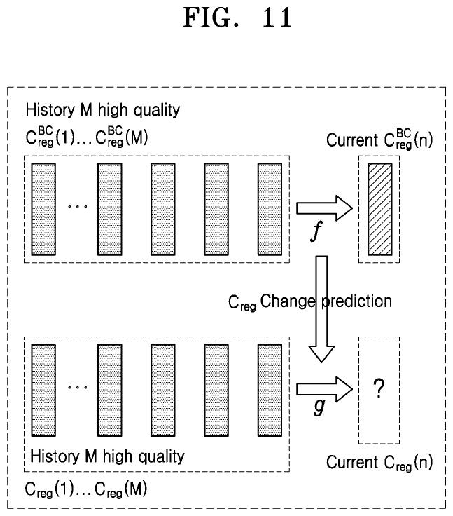

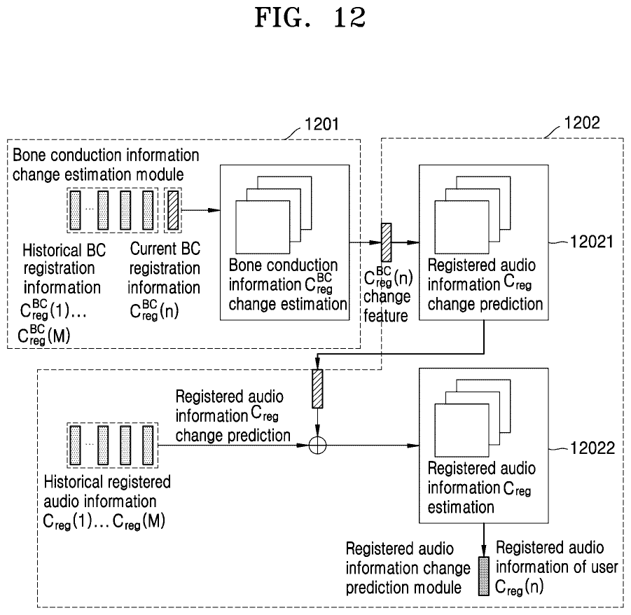

FIG. 10 is further described below using FIGS. 11-12.

FIG. 11 illustrates a schematic diagram of generating updated registered audio information associated with a user according to example embodiments of the disclosure. Referring to FIG. 11, a change function ƒ(⋅) of the historical BC registration information C_{reg}^{BC}(1), C_{reg}^{BC}(2), . . . , C_{reg}^{BC}(M) to the current BC registration information C_{reg}^{BC}(n) may be obtained, and a change function g(⋅) of the registered audio information C_{reg} may be predicted from the change function ƒ(⋅). The registered audio information from the AC signal C_{reg}(n) (e.g., the current C_{reg}(n)) may be obtained as the registered audio information associated with the user based on the historical registered audio information C_{reg}(1), C_{reg}(2), . . . , C_{reg}(M) and the change function g(⋅). Here, the historical registered audio information C_{reg}(1), C_{reg}(2), . . . , C_{reg}(M) may be M (wherein M is a positive integer) pieces of registered audio information associated with the user on which the extracted audio evaluated to be of a highest quality has been based, or which the extracted audio evaluated to be of a highest quality have used, and the historical BC registration information may correspond to the historical registered audio information.

FIG. 12 illustrates a workflow diagram of updating registered audio information associated with a user according to example embodiments of the disclosure. Referring to FIG. 12, the operation of updating the registered audio information associated with the user may be divided into the operations of two modules, for example: a BC information change estimation module 1201 and a registered audio change prediction module 1202.

The BC information change estimation module 1201 may learn the change feature of the BC registration information 2222 from the historical BC registration information 2212 and the current BC registration information 2214. When the user's voice changes, the change of the BC signal and the change of the AC signal may be related and regular, both in terms of subjective hearing and objective measurements. An AI model (e.g., the first AI model 2210) may be used to learn the change feature of the BC registration information 2222 from the historical 2212 and current BC registration information 2214. Inputs to the BC information change estimation module 1201 may include the historical BC registration information 2212 C_{reg}^{BC}(1), C_{reg}^{BC}(2), . . . , C_{reg}^{BC}(M) and the current BC registration information 2214 C_{reg}^{BC}(n) and an output may include the change feature from the historical BC registration information 2222 to the current BC registration information 2214.

The registered audio change prediction module 1202 may include two sub-modules, for example a registered audio information change prediction sub-module 12021 (e.g., the second AI model 2220) and a registered audio information estimation sub-module 12022 (e.g., the third AI model 2230).

The change feature of the BC registration information 2222 may be input to the registered audio information change prediction sub-module 12021, and the registered audio information change prediction sub-module 12021 may predict and output the change feature of the registered audio information 2232 (or a change feature of registered voice information).

Because the BC signal may be reliable for current speaker characteristics and may only be relevant to the user, it may be able to reflect the low-frequency change feature of the registered audio information from the AC signal. When the user's voice changes, the change of the BC signal and the change of the AC signal (the audio signal) may be related and regular, both in terms of subjective hearing and objective measurements. Therefore, the change of the AC signal may be deduced from the change of the BC signal.

The change feature of the registered audio information 2232 and the historical registered audio information 2234 (or the historical registered voice information) C_{reg}(1), C_{reg}(2), . . . , C_{reg}(M) may be input to the registered audio information estimation sub-module 12022, and the registered audio information estimation sub-module 12022 may output the registered audio information from the AC signal (e.g., the current registered voice information) as the registered audio information associated with the user 2236.

Here, the historical registered audio information 2234 C_{reg}(1), C_{reg}(2), . . . C_{reg}(M) and the historical BC registration information 2212 C_{reg}^{BC}(1), C_{reg}^{BC}(2), . . . , C_{reg}^{BC}(M) may be M (where M is a positive integer) pieces of registered audio information associated with user 2236 (e.g., the registered audio information from the AC signal) previously collected and their corresponding BC registration information, and may also be selected M (where M is a positive integer) pieces of registered audio information associated with the user 2236 on which the extracted audio evaluated to be of a highest quality has been based or which the extracted audio evaluated to be of a highest quality have used according to results of the evaluation by the extracted voice quality evaluation module 210.

Here, a time period of a selected segment of the historical BC signal may correspond to the historical registered audio signal. High-quality historical registered audio information may reflect a stable characteristic of the user, and through combining it with the change feature of the registered audio information predicted from the change feature of the BC registration information, changed registered audio information from the AC signal may be generated.

It should be understood that the workflow diagram FIG. 12 of updating registered audio information associated with the user is only example and that some modules may be omitted or other modules may be added, and the disclosure is not limited thereto.

In embodiments of the disclosure, when the user's voice changes, the registered audio information associated with the user 2236 may be updated to get the correct extracted voice. Some comparative example techniques based on the registration information associated with the target speaker often may not include updating the registered audio information associated with the user after registering a voice in advance. When the user's voice changes, the large differences between the changed user's voice feature and the pre-registered audio feature may lead to errors in extraction results, so the user may be required to perform re-registration. However, the registration environment may be demanding, and changes in the user's voice may be more common in life scenarios, and frequent registration may bring great inconvenience to the user. Therefore, according to embodiments of the present disclosure, the registered audio information associated with the user may be updated in real time through the BC signal when the user's voice changes without requiring the user to re-register, which may improve the user experience.

Returning to FIG. 3, in step S320, a second audio signal of the user may be extracted from a first audio signal based on the registered audio information associated with the user.

According to embodiments of the disclosure, a feature of the first audio signal may be obtained; a mask corresponding to the user may be obtained based on the registered audio information associated with the user and the feature of the first audio signal; and the second audio signal may be extracted based on the mask and the feature of the first audio signal.

According to embodiments of the disclosure, the mask corresponding to the user may be obtained based on the registered audio information associated with the user, the feature of the first audio signal, and a feature of the BC signal, using a fourth AI model.

Referring back to FIG. 2, the voice extraction module 230 may output the mask about the user based on the registered audio information associated with the user, and the feature of the first audio signal (e.g., the feature of the mixed voice) and the feature of the BC signal output by the encoding (e.g., the encoder 240 in FIG. 2). The voice extraction module 230 may be implemented by an AI model (e.g., a fourth AI model), inputs of the AI model may include the registered audio information associated with the user, the feature of the mixed voice and the feature of the BC signal, and it outputs the mask about the user. The AI model may be, for example, a neural network model (an attention model), but the disclosure is not limited thereto, and the AI model may also be neural network models including a convolutional neural network (CNN), a deep neural network (DNN), a recurrent neural network (RNN), a restricted boltzmann machine (RBM), a deep belief network (DBN), a bidirectional recurrent deep neural network (BRDNN), a generative adversarial network (GAN), and deep Q network, or other A1 models.

According to embodiments of the disclosure, obtaining the feature of the first audio signal may include: performing a feature extraction on the first audio signal to obtain a first frequency domain feature; performing frequency band dividing on the first frequency domain feature to obtain respective sub-frequency domain features of a plurality of sub-bands; and feature encoding may be performed on the sub-frequency domain features of the plurality of the sub-bands respectively to obtain features of the plurality of the sub-bands of the first audio signal as the feature of the first audio signal.

In order to model the audio signal and use a network to learn the intrinsic connections of the signal, the voice extraction module 230 may first perform feature extraction on the signal to obtain high-dimensional information. The voice extraction module 230 may encode the input audio signal and obtain a high-dimensional feature vector.

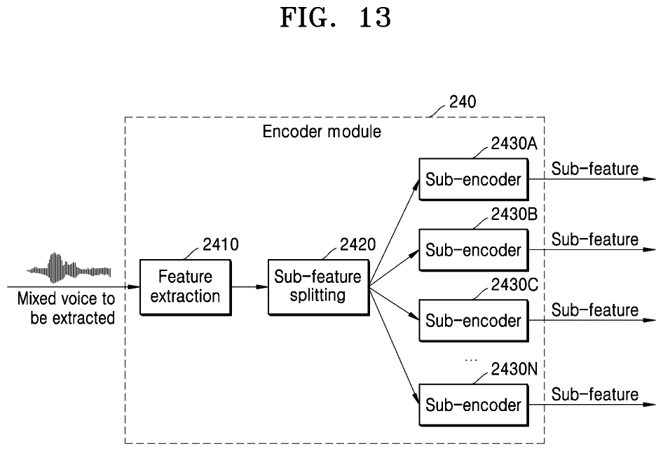

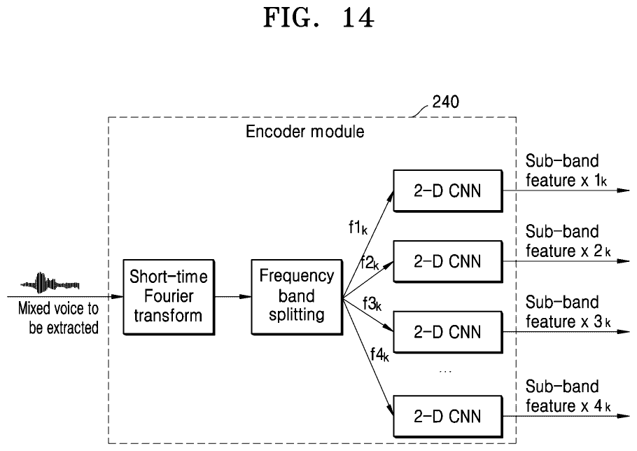

FIG. 13 illustrates a diagram of an encoder module 240 according to example embodiments of the disclosure. FIG. 14 illustrates a network flowchart of an encoder module 240 according to example embodiments of the disclosure.

An audio signal described below may be obtained at a sampling rate of 16 k for example, and duration of the input audio signal may be 4 s for example. For practical use, a signal of any length may be input. Referring to FIG. 13 and FIG. 14, the encoder module 240 may perform parallel processing using sub-bands. The encoder module 240 may include a feature extraction module 2410, a sub-feature splitting module 2420, and a plurality of sub-encoders 2430.

The feature extraction module 2410 may perform feature extraction for an input time-domain signal (e.g., a mixed voice signal or a BC signal), the feature extraction module 2410 may obtain a feature vector in another dimension (e.g., in the frequency domain), which may facilitate the model's modeling and learning of the input signal. The feature extraction module 2410 may be implemented using a STFT as shown in FIG. 14, or other feature extraction methods, for example, using an AI model (e.g., a convolutional neural network, CNN) for the feature extraction.

In an embodiment, the feature extraction module 2410 may use STFT, and the input signal s1 is subjected to framing, windowing and the short-time Fourier transform to obtain the feature in the frequency domain (e.g., the first frequency domain feature). Sampling the signal of n seconds duration at a sampling rate of 16 k for example, there are sampling point data L=n*16000. STFT with point number sₙ (e.g., the number of sampling points per frame is sₙ) is performed, and the overlap region between frames is sₙ/2 (50% overlap); after STFT, the number of frames may be expressed according to Equation 2 below:

$$k = L / ( {s}_{n} / 2 ) - 1 \qquad Equation 2$$

The number of frequency points per frame may be expressed according to Equation 3 below:

$$f = {s}_{n} / 2 \qquad Equation 3$$

The real and imaginary parts of the frequency domain are taken out respectively, and then the dimension of the output feature vector is [k, 2*f].

For example, the frequency point of the real part, the number is [k, f]. For example, the frequency point of the imaginary part, the number is [k, f]. For example, when outputting the features, the frequency points of the real and imaginary parts are concatenated together, so it is [k, 2*f].

For calculating STFT of a signal of 4 s with 512 points, the number of frequency points per frame may be obtained as sₙ/2=512/2=256, and the dimension of the feature vector ƒₖ (e.g., the first frequency domain feature) is obtained as [249, 256], that is, there are 249 frames with 256 frequency points per frame. Each frequency point may be represented using one real and one imaginary part, wherein k={0, 1, 2, . . . , 248} represents the frame number.

The encoder module 240 may directly use an encoder for encoding to obtain the higher dimensional feature vector after performing the previous step of the feature extraction, or may divide the feature and encode sub-features using their respective encoders as a way to reduce complexity of the model and improve processing speed of the model, for example by using frequency band splitting or dividing.

Embodiments of the disclosure may use encoding of the sub-band feature to, for example, split the 16 k frequency band into N sub-bands. Usually, the more sub-bands it is divided into, the finer the feature processing is, but more sub-encoders are introduced, which in turn may increase model complexity. According to the embodiments, taking performance and model complexity into account, 4-6 encoders may be used for example.

In embodiments of the disclosure, the sub-feature splitting module 2420 may perform frequency band splitting on the frequency domain feature (e.g., the first frequency domain feature) to obtain frequency domain features of a plurality of sub-bands (e.g., sub-frequency domain features of a plurality of sub-bands), for example, the division of 4 sub-bands may be adopted for the feature data in the frequency domain obtained in the previous step, the data of 256 frequency points per frame is divided into 4 sub-bands ƒ1ₖ, ƒ2ₖ, ƒ3ₖ, ƒ4ₖ, and each sub-band includes frequency points as {1-32}, {33-64}, {65-128}, {129-256} corresponding to frequencies 0-2 k, 2 k-4 k, 4 k-8 k, 8 k-16 k.

If the operation of frequency band division is not performed, only one encoder module may be used to encode the full band features to obtain the higher dimensional feature vector. Because embodiments of the disclosure may use sub-band processing, the full band feature may be divided into a plurality of sub-band features, and each sub-band feature may be encoded using a different sub-encoder from the plurality of sub-encoders 2430 (e.g., a 2-D CNN operation may be performed on the sub-band feature, as shown in FIG. 14), thereby realizing parallel encoding and reducing complexity. For example, the number of sub-band division is N, there may be N sub-encoders 2430A, 2430B, 2430C, . . . 2430N corresponding to the sub-band features. In embodiments of the disclosure, there are 4 sub-encoders (sub-band encoders) for example, each of which may process the corresponding sub-band feature to be encoded into the higher dimensional feature vector.

Examples of calculating sub-band feature vectors are provided below.

Calculating of the sub-band feature vector x1ₖ. the dimension of the sub-band ƒ1ₖ [249,64] may be expanded to [1,1,249,64], and a 2-dimensional convolution operation may be performed with an output channel of 256, a convolution kernel of 5*5, and a step size of 1*1 to obtain the output vector x1ₖ [1, 256, 249, 64].

Calculating of the sub-band feature vector x2ₖ: the dimension of the sub-band ƒ2ₖ [249,64] may be expanded to [1,1,249,64], and a 2-dimensional convolution operation may be performed with an output channel of 256, a convolution kernel of 5*5, and a step size of 1*1 to obtain the output vector x2ₖ [1, 256, 249, 64].

Calculating of the sub-band feature vector x3ₖ: the dimension of the sub-band ƒ3ₖ [249,128] may be expanded to [1,1,249,128], and a 2-dimensional convolution operation may be performed with an output channel of 256, a convolution kernel of 5*6, and a step size of 1*2 to obtain the output vector x3ₖ [1, 256, 249, 64].

Calculating of the sub-band feature vector x4ₖ: the dimension of the sub-band ƒ4ₖ [249,256] may be expanded to [1,1,249,256], and a 2-dimensional convolution operation may be performed with an output channel of 256, a convolution kernel of 5*6, and a step size of 1*4 to obtain the output vector x4ₖ [1, 256, 249, 64].

After processing by the encoder, the dimension of each sub-band feature vector xiₖ may be [1,256,249,64].

Both the mixed voice (e.g., the first audio signal) and the BC signal may be used as the input to the encoder module described above, thereby outputting features of a plurality of sub-bands of the mixed voice and features of a plurality of sub-bands of the BC signal.

According to embodiments of the disclosure, a feature of each sub-band of the second audio signal may be obtained based on a mask in the mask corresponding to each sub-band of the plurality of the sub-bands of the first audio signal and the feature of each sub-band of the first audio signal; feature decoding may be performed on the features of the plurality of the sub-bands of the second audio signal respectively to obtain second frequency domain features of the plurality of the sub-bands; frequency band merging may be performed on the second frequency domain features of the plurality of the sub-bands; and the second audio signal may be obtained based on the merged second frequency domain features.

In the decoding operation, a dot-multiplication operation may be performed on the mask about the user obtained from the voice extraction module 230 and the features of the mixed voice output by the encoder, and further feature decoding may be carried out to recover a time-domain signal of the target voice.

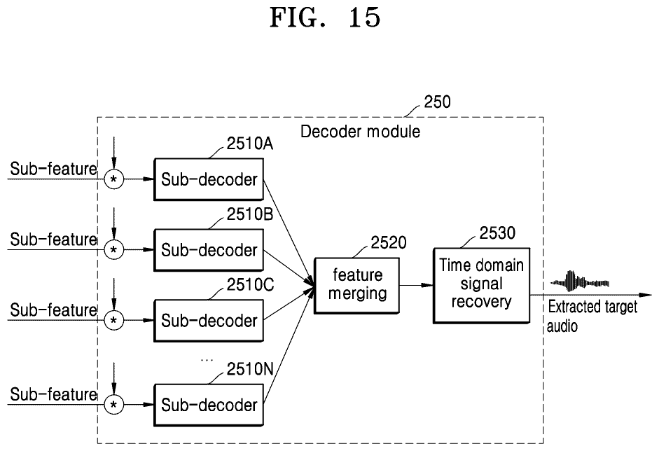

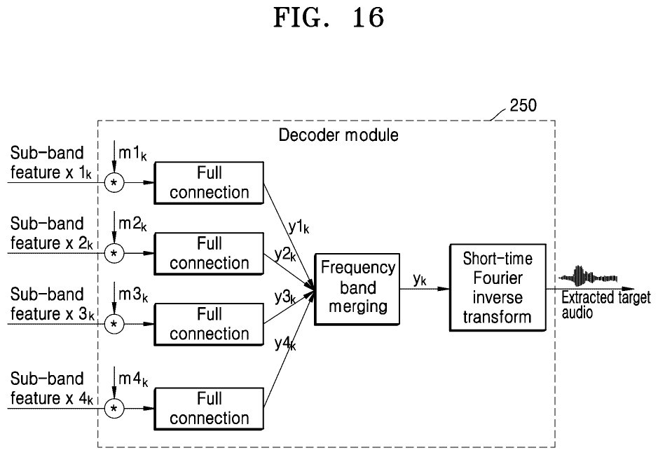

FIG. 15 illustrates a diagram of a decoder module according to example embodiments of the disclosure. FIG. 16 illustrates a network flowchart of a decoder module according to example embodiments of the disclosure. Referring to FIG. 15 and FIG. 16, the decoder module includes the following three operations:

A dot-multiplication operation of corresponding elements of the sub-band mask miₖ predicted by the voice extraction module 230 and the sub-band features xiₖ output by the encoder module 240 may be performed (to obtain features of the plurality of sub-bands of the second audio signal), and then feature decoding (an inverse procedure of feature encoding, e.g., an inverse procedure of the above-described 2-D CNN operation) may be performed using a plurality of sub-decoders 2510, for example through a linear full connection layer as shown in FIG. 16. For example, if the number of sub-band division is N, there may be N sub-decoders 2510A, 2510B, 2510C, . . . 2510N corresponding to the sub-band features. According to embodiments, other methods may also be used to perform feature decoding, for example, but not limited to the use of AI model (e.g., a convolutional neural network CNN) and so on, the sub-band frequency domain features yiₖ of the second audio signal (e.g., the second frequency domain feature of the sub-band) is obtained, wherein i denotes the ith sub-band and k denotes the kth frame.

To perform feature merging, the obtained sub-band frequency domain features yiₖ may be merged by the feature merging module 2520 to obtain the frequency domain feature yₖ (e.g., the second frequency domain feature), which facilitates the processing of signal recovery later.

To perform time domain signal recovery, a time domain signal recovery module 2530 may perform, for example, a short-time Fourier inverse transform may be used, or other methods of feature transformation may be used, for example, but not limited to, the use of an AI model (e.g., a convolutional neural network CNN), etc. for voice signal recovery. In embodiments of the disclosure, the encoder module employs the short-time Fourier transform for feature extraction, so here the short-time Fourier inverse transform (e.g., a 512-point short-time Fourier inverse transform) is performed on the features to obtain the extracted time-domain signal of the target object as the extracted target audio (e.g., the second audio signal).

Returning to FIG. 3, in step S330, at least one from among the extracted second audio signal and a portion of the first audio signal which does not contain the second audio signal may be processed.

For example, the third audio signal may include the music.

According to embodiments of the disclosure, at least one from among the extracted second audio signal and a portion of the first audio signal which does not contain the second audio signal may be amplified, or the second audio signal may be mixed with a third audio signal.

According to embodiments of the disclosure, the extracted second audio signal and the portion of the first audio signal which does not contain the second audio signal may be amplified in different proportions.

In embodiments of the disclosure, at least one from among the extracted audio signal and the mixed voice which does not contain the extracted audio signal may be amplified, and the extracted audio signal and the mixed voice which does not contain the extracted audio signal may be differently amplified (e.g., in different proportions). In addition, the extracted audio signal may be mixed with other audio signals (e.g., music) in order to meet different needs of the user. Examples of this are described below in conjunction with the following chat scenario and in-ear monitor scenario.

The method of the disclosure may be applied to a scenario where a user is chatting with a person, and ambient sound amplification may be used, which may refer to amplifying all sounds that can be captured in order to be clearly heard by the user, but this indiscriminate amplification may make the user's voice too loud and jarring. Embodiments of the disclosure may be used to extract the user's voice from the ambient sound and differently amplify the user's own voice and the ambient sound (e.g., the user's own voice is amplified two times and the ambient sound is amplified five times), which may enable the user to have a better listening experience. The steps in this scenario may include: a switch may be turned on for extracting one's own voice in an ambient sound amplification mode; the earphone may pick up one's own voice and surrounding voice, and extract one's own voice from the surrounding voice; and the user may hear the distant voice and his or her own voice will not be over-amplified.

The method of the disclosure may be applied in an in-ear monitor scenario in which a user, when singing, may desire to hear his or her own voice to determine whether rhythms and intonations of the song are correct. When the user is singing on stage, he needs in-ear monitor to hear rhythms of his or her song because speakers may be facing the audience and the noise may be too loud in the stage. In addition, embodiments of the disclosure may be applied to, for example, an earphone, which is needed to listen to the accompaniment when the user is singing with a karaoke application at home or in some small public places, where environmental noise, reverberation, and the like may result in the user being unable to hear his or her song clearly. Embodiments of the disclosure may be used to extract the user's voice from the ambient sound, the steps in this scenario may include: a button may be turned on by the user for his or her own voice extraction in an ambient sound mode; the user's own voice may start to be extracted from the noisy environment; and the user's own voice may be mixed with music tempo and played in the earphone.

Embodiments of the disclosure may be applied to some scenarios where the user does not need to speak, such as listening to a report, etc., and the user may turn off the extraction function button to reduce the demand of the function on power consumption of the extraction device (e.g., the earphone). The steps in this scenario may include: the user may select to turn off the button for extracting his or her own voice; and then in the subsequent signal reception of the earphone, the user can hear and clearly hear voice of a distant speaker. This scenario may be appropriate when the user does not need to speak, and the voice extraction function may be selected to be on or off by an user interface provided by the extraction device, so that power consumption may be saved when the user selects to turn it off.

According to the above-described methods, the quality of the extracted audio may be evaluated based on the BC signal, and the registered audio information associated with the user may be updated in real time by the BC signal based on the evaluated quality of the extracted audio being low, for example below a threshold quality value. According to embodiments, the advance registration of the user's voice may not be required. In some comparative example voice extraction techniques, a pre-registration may be required because a certain amount of input, for example at least one sentence, may need to be input to decouple the content of the voice from the voice signal in order to eliminate the effect on the content and to obtain a global expression of the speaker's voice feature. In addition, because changes in the environment, such as the generation of ambient noise, may lead to failure of registration, the registered voice needs to be captured in a quieter environment, and the requirements for the capturing environment are more stringent. In contrast, embodiments of the present disclosure may not require advance registration of the user's voice, which may greatly facilitate the user and improves the user experience. Further, embodiments of the disclosure may enable an adaptive real-time registration of the user's voice, even if, in some cases, the user's voice feature changes (including passive changes and active changes, wherein the passive changes are that the user may be hoarse due to a cold or a sore throat, and the user's vocal cords may experience edema in many cases, such as changes in weather/location, and the user's consumption of alcohol or physical fatigue, and the active changes are that the user, when singing, will change the pitch and timbre of the voice, such as the pitch becoming sharp, and the user's voice is more likely to sound very different), real-time updating of the registered voice can be achieved using the method of the disclosure, which improves the quality of the voice extraction and the naturalness of the voice.

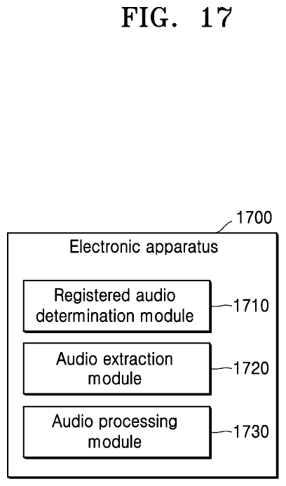

FIG. 17 illustrates a schematic block diagram of an electronic apparatus according to example embodiments of the disclosure.

Referring to FIG. 17, the electronic apparatus 1700 of the disclosure may include a registered audio determination module 1710, an audio extraction module 1720, and an audio processing module 1730. The registration audio determination module 1710 may determine registered audio information associated with a user based on a BC signal, the audio extraction module 1720 may extract a second audio signal of the user from a first audio signal based on the registered audio information associated with the user; the audio processing module 1730 may process the extracted second audio signal and/or the first audio signal that does not contain the second audio signal.

According to embodiments of the disclosure, the registered audio determination module 1710 may be configured to determine the registered audio information associated with the user based on the BC signal. For example, the registered audio determination module 1710 may be configured to: evaluate a quality of a previously-extracted second audio signal based on content of the previously-extracted second audio signal and the BC signal; determine the registered audio information associated with the user based on the quality of the previously-extracted second audio signal.

According to embodiments of the disclosure, the registered audio determination module 1710 may be configured to classify the previously-extracted second audio signal and the BC signal based on a voice feature; determine a matching probability between a category of the previously-extracted second audio signal and a category of the BC signal; evaluate the quality of the previously-extracted second audio signal based on the matching probability.

According to embodiments of the disclosure, the registered audio determination module 1710 may be configured to classify the previously-extracted second audio signal and the BC signal, respectively, using a pre-trained classifier, and lookup a matching probability graphic obtained by pre-training for the category of the previously-extracted second audio signal and the category of the BC signal to determine the matching probability.

According to embodiments of the disclosure, the registered audio determination module 1710 may be configured to determine a need to update the registered audio information associated with the user based on the quality of the previously-extracted second audio signal; determine a feature change trend of BC registration information; predict registered audio information from an AC signal as the registered audio information associated with the user based on the feature change trend of the BC registration information.

According to embodiments of the disclosure, the registered audio determination module 1710 may be configured to determine to update the registered audio information associated with the user in case that the quality of the previously-extracted second audio signal does not satisfy a predetermined condition; and determine not to update the registered audio information associated with the user in the case that the quality of the previously-extracted second audio signal satisfies the predetermined condition.

According to embodiments of the disclosure, the registered audio determination module 1710 may be configured to determine the feature change trend of the BC registration information, based on historical BC registration information and current BC registration information, using a first AI model, and predict a feature change trend of the registered audio information from the AC signal, based on the feature change trend of the BC registration information, using a second AI model, and obtain the registered audio information from the AC signal as the registered audio information associated with the user, based on the feature change trend of the registered audio information from the AC signal and historical registered audio information from the AC signal, using a third AI model.

According to embodiments of the disclosure, the historical registered audio information from the AC signal may include the registered audio information corresponding to the previously-extracted second audio signal evaluated to be of a highest quality, and wherein the historical BC registration information corresponds to the historical registered audio information from the AC signal.

According to embodiments of the disclosure, the audio extraction module 1720 may be configured to obtain a feature of the first audio signal; obtain a mask corresponding to the user based on the registered audio information associated with the user and the feature of the first audio signal; and extract the second audio signal based on the mask and the feature of the first audio signal.

According to embodiments of the disclosure, the audio extraction module 1720 is configured to obtain the mask about the user, based on the registered audio information associated with the user, the feature of the first audio signal, and a feature of the BC signal, using a fourth AI model.

According to embodiments of the disclosure, the audio extraction module 1720 may be configured to perform a feature extraction on the first audio signal to obtain a first frequency domain feature; perform frequency band dividing on the first frequency domain feature to obtain respective sub-frequency domain features of a plurality of sub-bands; and perform feature encoding on the sub-frequency domain features of the plurality of the sub-bands respectively to obtain features of the plurality of the sub-bands of the first audio signal as the feature of the first audio signal.

According to embodiments of the disclosure, the audio extraction module 1720 may be configured to obtain a feature of each sub-band of the second audio signal based on a mask in the mask corresponding to each sub-band of the plurality of the sub-bands of the first audio signal and the feature of each sub-band of the first audio signal; perform feature decoding on the features of the plurality of the sub-bands of the second audio signal respectively to obtain second frequency domain features of the plurality of the sub-bands; perform frequency band merging on the second frequency domain features of the plurality of the sub-bands; and obtain the second audio signal based on the merged second frequency domain features.

According to embodiments of the disclosure, the audio processing module 1730 may be configured to amplify the extracted second audio signal and/or the first audio signal that does not contain the second audio signal, or mix the second audio signal with a third audio signal.

According to embodiments of the disclosure, the audio processing module 1730 may be configured to amplify the extracted second audio signal and the first audio signal that does not contain the second audio signal in different proportions.

According to the above-described device for voice extraction, the quality of the extracted audio is evaluated based on the BC signal, and the registered audio information associated with the user is updated in real time by the BC signal based on the quality of the evaluated extracted audio being low, which may allow an adaptive real-time registration of the user's voice. Accordingly, the advance registration of the user's voice may not be required, which may improve the user experience. Further, real-time updating of the registered voice may also be performed when the user's voice feature changes, which improves the quality of voice extraction and the naturalness of the voice.

Accordingly, embodiments may extract a user's own voice from mixed voice using automatic voice registration without pre-including the target registered voice. Applicable scenarios include a voice call, chatting, and hardware used by embodiments may include: a TWS having a VPU (or a related hardware unit that can receive or obtain the BC signal).

The results of the disclosure for the actual measurement of the target object are shown in Table 1 below:

TABLE 1

| | Tests with different | | | | |
|---|---|---|---|---|---|
| | signal-to-noise SNR(dB) | | | | Average |
| | 0 | 5 | 10 | 15 | SISDR |
| SISDR (dB) | 5.21 | 6.74 | 9.53 | 9.22 | 7.68 |
| according to | | | | | |
| comparative | | | | | |
| example | | | | | |
| techniques | | | | | |
| SISDR (dB) | 7.09 | 9.78 | 11.68 | 12.69 | 10.31 |
| according to | | | | | |
| example | | | | | |
| embodiments of | | | | | |
| the disclosure | | | | | |
| Improvement | 36.07% | 45.19% | 22.61% | 37.59% | 34.24% |
| Ratio | | | | | |

To illustrate that embodiments may maintain the performance of voice extraction when voice changes, an experiment was performed in which three types of noise were mixed, for example noisy voice noise (sound of multiple speakers), car, and music with WSJO data to simulate real complex environment with signal-to-noise ratios (SNR) of 0, 5, 10, and 15 dB, respectively. The evaluation metric adopts scale invariant signal-to-distortion ratio (SISDR). The SISDR is a common metric used to evaluate the performance of extraction methods, which may be a ratio expressed in dB, where higher indicates better performance.

The results show that, in an average SISDR, the comparative example techniques achieve an the average SISDR of 7.68 dB when using 0.5 s of registration sound, when compared to the average result of 10.31 dB of the disclosure, it is a 34.2400 improvement in the performance of the disclosure. This shows that the method of the disclosure performs better than the comparative example techniques. And even when the ambient noise is high, the method of the disclosure may still extract voice of the target object well.

Embodiments of the disclosure may be applied to target voice extraction in voice calls or recorded audio from cell phones or headsets. Using embodiments of the disclosure, the real-time imperceptible registration of the target object and the real-time update of the registered voice may be realized, and the voice of the target object may be extracted based on the registered voice, and at the same time, the language quality and voice naturalness of the call may be significantly improved. In addition, the example network according to embodiments of the disclosure may be applied not only to the task of the voice extraction, but also may be used in tasks of a voice enhancement and a voice separation. Embodiments described herein may be consistent with FIG. 2, for example, embodiments may be used to achieve the tasks of the voice enhancement and the voice separation without making modifications to the model, but only with changes to the input training data and the training target.

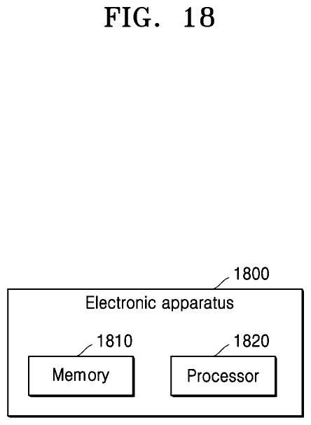

FIG. 18 illustrates a block diagram of an electronic apparatus according to example embodiments of the disclosure. Referring to FIG. 18, the electronic apparatus 1800 may include at least one memory 1810 and at least one processor 1820, the at least one memory storing computer-executable instructions, the computer-executable instructions, when executed by the at least one processor, enabling the at least one processor 1820 to execute the method performed by the electronic apparatus according to embodiments of the disclosure.

At least one of the plurality of modules described above may be implemented by an AI model. Functions associated with the A1 may be performed through non-volatile memory, volatile memory and processors.

The processors may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model may be provided through training or learning. Here, being provided through learning means that, by applying a learning algorithm to a plurality of learning data, a predefined operating rule or A1 model of a desired characteristic is made. The learning may be performed in a device itself in which A1 according to embodiments is performed, and/or may be implemented through a separate server/device/system.

The learning algorithm may be a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

According to the present invention, in an image processing method performed by an electronic device, an output image after processing of a target region may be obtained by using an input image as input data for the artificial intelligence model.

The artificial intelligence model may be obtained through training. Here, “obtained through training” means training a basic artificial intelligence model with a plurality of training data through a training algorithm, thereby obtaining a predefined operating rule or AI model, the operating rule or AI model being configured to perform a desired characteristic (or purpose).

As an example, the artificial intelligence model may include a plurality of neural network layers. Each of the plurality of neural network layers includes a plurality of weight values and performs a neural network calculation through calculation between results of a previous layer and the plurality of weight values. Examples of neural networks include, but are not limited to, a convolutional neural network (CNN), a deep neural network (DNN), a recurrent neural network (RNN), a restricted boltzmann machine (RBM), a deep belief network (DBN), a bidirectional recursive deep neural network (BRDNN), a generative adversarial network (GAN), and a deep Q-Network. As examples, the electronic apparatus may be a personal computer (PC), a tablet device, a personal digital assistant, a smartphone, or other device capable of executing the above-described set of instructions. Here, the electronic apparatus may not be a single electronic apparatus, but may also be any collection of devices or circuits capable of executing the instructions (or instruction set) individually or in combination. The electronic apparatus may also be part of an integrated control system or system manager, or may be configured to be an electronic apparatus connecting via a local or remote (e.g., via wireless transmission) interface.

In an electronic apparatus, the processor may include a central processing unit (CPU), a graphic processing unit (GPU), a programmable logic device, a dedicated processor system, a microcontroller, or a microprocessor. As an example and not a limitation, a processor may also include an analog processor, a digital processor, a microprocessor, a multi-core processor, a processor array, a network processor, and the like.

The processor may run instructions or code stored in the memory, wherein the memory may also store data. The instructions and data may also be sent, and received, over a network via a network interface device, wherein the network interface device may employ any known transmission protocol.

The memory may be integrated with the processor, for example, by arranging RAM or flash memory within an integrated circuit microprocessor. In addition, the memory may include a separate device, such as an external disk drive, a storage array, or other storage device. The memory and the processor may be operationally coupled or may communicate with each other, for example, via I/O ports, network connections, etc., so that the processor may read the files stored in the memory.

In addition, the electronic apparatus may also include a video display (e.g., a liquid crystal display) and a user interface such as a keyboard, mouse, touch input device, etc). All components of the electronic apparatus may be connected to each other via a bus and/or network.

According to embodiments of the disclosure, a computer-readable storage medium storing instructions may also be provided, wherein the instructions when executed by at least one of processor, enable the at least one of processor implement the method performed by the electronic apparatus according to the exemplary embodiment of the present disclosure. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, compact disk (CD) memory, CD-ROM, CD-recordable (CD-R), CD+R, CD-rewritable (CD-RW), CD+RW, digital versatile disk (DVD) memory, DVD-ROM, DVD-R, DVD+R, DVD-RW, DVD+RW, DVD-RAM, blue-ray disk (BD), BD-ROM, BD-R, BD-R low to high (LTH), BD-recordable erasable (BD-RE), or optical disk memory, hard disk drive (HDD), solid state drive (SSD), card-based memory (such as, multimedia cards, Secure Digital (SD) cards or Extreme Digital (XD) cards), magnetic tapes, floppy disks, magneto-optical data storage devices, optical data storage devices, hard disks, solid state disks, and any other device, where the other device is configured to store the computer programs and any associated data, data files, and data structures in a non-transitory manner and to provide the computer programs and any associated data, data files, and data structures to a processor or computer, so that the processor or computer may execute the computer program. The instructions and the computer program in the computer readable storage medium above may run in an environment deployed in a computer device such as a terminal, client, host, agent, server, etc., and furthermore, in one example, the computer program and any associated data, data files and data structures are distributed on a networked computer system such that the computer program and any associated data, data files and data structures are stored, accessed, or executed in a distributed manner by one or more processors or computers.

Other embodiments of the disclosure will readily come to the mind of those skilled in the art upon consideration of the specification and practice of the invention disclosed herein. This application is intended to cover any variations, uses, or adaptations of the present disclosure that follow the general principles of the disclosure and include commonly known or customary technical means in the art that are not disclosed herein. The specification and embodiments are to be regarded as exemplary only, and the true scope and spirit of the present disclosure is defined by the claims.

According to the embodiment of the disclosure, the method may include evaluating a quality of a previously-extracted second audio signal based on content of the previously-extracted second audio signal and the BC signal. According to the embodiment of the disclosure, the method may include determining the registered audio information associated with the user based on the quality of the previously-extracted second audio signal.

According to the embodiment of the disclosure, the method may include classifying the previously-extracted second audio signal and the BC signal based on a voice feature. According to the embodiment of the disclosure, the method may include determining a matching probability between a category of the previously-extracted second audio signal and a category of the BC signal. According to the embodiment of the disclosure, the method may include evaluating the quality of the previously-extracted second audio signal based on the matching probability.

According to the embodiment of the disclosure, the method may include classifying the previously-extracted second audio signal and the BC signal using a pre-trained classifier. According to the embodiment of the disclosure, the method may include performing a lookup based on a matching probability graphic obtained by pre-training for the category of the previously-extracted second audio signal and the category of the BC signal to determine the matching probability.

According to the embodiment of the disclosure, the method may include determining whether to update the registered audio information associated with the user based on the quality of the previously-extracted second audio signal. According to the embodiment of the disclosure, the method may include determining a feature change trend of BC registration information. According to the embodiment of the disclosure, the method may include predicting registered audio information from an air conduction (AC) signal as the registered audio information associated with the user based on the feature change trend of the BC registration information.

According to the embodiment of the disclosure, the method may include determining to update the registered audio information associated with the user based on determining that the quality of the previously-extracted second audio signal does not satisfy a predetermined condition. According to the embodiment of the disclosure, the method may include determining not to update the registered audio information associated with the user based on determining that the quality of the previously-extracted second audio signal satisfies the predetermined condition.

According to the embodiment of the disclosure, the method may include determining the feature change trend of the BC registration information, based on historical BC registration information and current BC registration information, using a first artificial intelligence (AI) model According to the embodiment of the disclosure, the method may include predicting a feature change trend of the registered audio information from the AC signal, based on the feature change trend of the BC registration information, using a second AI model. According to the embodiment of the disclosure, the method may include obtaining the registered audio information from the AC signal as the registered audio information associated with the user, based on the feature change trend of the registered audio information from the AC signal and historical registered audio information from the AC signal, using a third A1 model.

According to the embodiment of the disclosure, the historical registered audio information from the AC signal may be the registered audio information corresponding to the previously-extracted second audio signal evaluated to be of a highest quality. According to the embodiment of the disclosure, the historical BC registration information may correspond to the historical registered audio information from the AC signal.

According to the embodiment of the disclosure, the method may include obtaining a feature of the first audio signal. According to the embodiment of the disclosure, the method may include obtaining a mask corresponding to the user based on the registered audio information associated with the user and the feature of the first audio signal. According to the embodiment of the disclosure, the method may include extracting the second audio signal based on the mask and the feature of the first audio signal.

According to the embodiment of the disclosure, the method may include obtaining the mask corresponding to the user, based on the registered audio information associated with the user, the feature of the first audio signal, and a feature of the BC signal, using a fourth AI model.

According to the embodiment of the disclosure, the method may include performing a feature extraction on the first audio signal to obtain a first frequency domain feature. According to the embodiment of the disclosure, the method may include performing frequency band dividing on the first frequency domain feature to obtain a plurality of sub-frequency domain features corresponding to a plurality of sub-bands of the first audio signal. According to the embodiment of the disclosure, the method may include performing feature encoding on the plurality of sub-frequency domain features to obtain a plurality of first features corresponding to the plurality of the sub-bands of the first audio signal as the feature of the first audio signal.

According to the embodiment of the disclosure, the method may include obtaining a plurality of second features corresponding to a plurality of sub-bands of the second audio signal based on a plurality of sub-masks in the mask corresponding to the plurality of sub-bands of the first audio signal and the plurality of first features. According to the embodiment of the disclosure, the method may include performing feature decoding on the plurality of second features to obtain a plurality of second frequency domain features corresponding to the plurality of sub-bands of the second audio signal. According to the embodiment of the disclosure, the method may include performing frequency band merging on the plurality of second frequency domain features. According to the embodiment of the disclosure, the method may include obtaining the second audio signal based on the merged plurality of second frequency domain features.

According to the embodiment of the disclosure, the method may include at least one of amplifying the at least one from among the extracted second audio signal and the portion of the first audio signal and mixing the extracted second audio signal with a third audio signal.

According to the embodiment of the disclosure, the method may include amplifying the extracted second audio signal and the portion of the first audio signal in different proportions.

According to the embodiment of the disclosure, the electronic apparatus is provided. The electronic apparatus may include a registered audio determination module configured to select registered audio information associated with a user based on a BC signal. The electronic apparatus may include an audio extraction module configured to extract a second audio signal corresponding to the user from a first audio signal based on the registered audio information associated with the user. The electronic apparatus may include an audio processing module configured to process at least one from among the extracted second audio signal and a portion of the first audio signal which does not contain the second audio signal.

According to the embodiment of the disclosure, an electronic comprising a memory, and at least one processor is provided. The one or more processor is further configured to execute the instructions to

According to the embodiment of the disclosure, the electronic comprising a memory, and at least one processor is provided. The one or more processor is further configured to execute the instructions to evaluate a quality of a previously-extracted second audio signal based on content of the previously-extracted second audio signal and the BC signal. The one or more processor is further configured to execute the instructions to determine the registered audio information associated with the user based on the quality of the previously-extracted second audio signal.

According to the embodiment of the disclosure, the electronic comprising a memory, and at least one processor is provided. The one or more processor is further configured to execute the instructions to classify the previously-extracted second audio signal and the BC signal based on a voice feature. The one or more processor is further configured to execute the instructions to determine a matching probability between a category of the previously-extracted second audio signal and a category of the BC signal. The one or more processor is further configured to execute the instructions to evaluate the quality of the previously-extracted second audio signal based on the matching probability.

According to the embodiment of the disclosure, the electronic comprising a memory, and at least one processor is provided. The one or more processor is further configured to execute the instructions to determine whether to update the registered audio information associated with the user based on the quality of the previously-extracted second audio signal. The one or more processor is further configured to execute the instructions to determine a feature change trend of BC registration information. The one or more processor is further configured to execute the instructions to predict registered audio information from an air conduction (AC) signal as the registered audio information associated with the user based on the feature change trend of the BC registration information.

According to the embodiment of the disclosure, the electronic comprising a memory, and at least one processor is provided. The one or more processor is further configured to execute the instructions to obtain a feature of the first audio signal. The one or more processor is further configured to execute the instructions to obtain a mask corresponding to the user based on the registered audio information associated with the user and the feature of the first audio signal. The one or more processor is further configured to execute the instructions to extract the second audio signal based on the mask and the feature of the first audio signal.

What is claimed is:

1. A method performed by an electronic apparatus comprising:
determining registered audio information associated with a user based on a bone conduction (BC) signal;
extracting a second audio signal corresponding to the user from a first audio signal based on the registered audio information associated with the user; and
processing the at least one from among the extracted second audio signal and a portion of the first audio signal which does not contain the second audio signal.

2. The method of claim 1, wherein the determining of the registered audio information associated with the user based on the BC signal comprises:
evaluating a quality of a previously-extracted second audio signal based on content of the previously-extracted second audio signal and the BC signal; and
determining the registered audio information associated with the user based on the quality of the previously-extracted second audio signal.

3. The method of claim 2, wherein the evaluating of the quality of the previously-extracted second audio signal comprises:
classifying the previously-extracted second audio signal and the BC signal based on a voice feature;
determining a matching probability between a category of the previously-extracted second audio signal and a category of the BC signal; and
evaluating the quality of the previously-extracted second audio signal based on the matching probability.

4. The method of claim 3, wherein the classifying of the previously-extracted second audio signal and the BC signal based on the voice feature comprises classifying the previously-extracted second audio signal and the BC signal using a pre-trained classifier, and
wherein the determining of the matching probability between the category of the previously-extracted second audio signal and the category of the BC signal comprises performing a lookup based on a matching probability graphic obtained by pre-training for the category of the previously-extracted second audio signal and the category of the BC signal to determine the matching probability.

5. The method of claim 2, wherein the determining of the registered audio information associated with the user based on the quality of the previously-extracted second audio signal comprises:
determining whether to update the registered audio information associated with the user based on the quality of the previously-extracted second audio signal;
determining a feature change trend of BC registration information; and
predicting registered audio information from an air conduction (AC) signal as the registered audio information associated with the user based on the feature change trend of the BC registration information.

6. The method of claim 5, wherein the determining whether to update the registered audio information associated with the user based on the quality of the previously-extracted second audio signal comprises:
determining to update the registered audio information associated with the user based on determining that the quality of the previously-extracted second audio signal does not satisfy a predetermined condition; and
determining not to update the registered audio information associated with the user based on determining that the quality of the previously-extracted second audio signal satisfies the predetermined condition.

7. The method of claim 5, wherein the determining of the feature change trend of the BC registration information comprises determining the feature change trend of the BC registration information, based on historical BC registration information and current BC registration information, using a first artificial intelligence (AI) model, and
wherein the predicting of the registered audio information from the AC signal as the registered audio information associated with the user based on the feature change trend of the BC registration information comprises:
predicting a feature change trend of the registered audio information from the AC signal, based on the feature change trend of the BC registration information, using a second AI model, and
obtaining the registered audio information from the AC signal as the registered audio information associated with the user, based on the feature change trend of the registered audio information from the AC signal and historical registered audio information from the AC signal, using a third AI model.

8. The method of claim 7, wherein the historical registered audio information from the AC signal comprises the registered audio information corresponding to the previously-extracted second audio signal evaluated to be of a highest quality, and
wherein the historical BC registration information corresponds to the historical registered audio information from the AC signal.

9. The method of claim 1, wherein the extracting of the second audio signal corresponding to the user from the first audio signal based on the registered audio information associated with the user comprises:
obtaining a feature of the first audio signal;
obtaining a mask corresponding to the user based on the registered audio information associated with the user and the feature of the first audio signal; and
extracting the second audio signal based on the mask and the feature of the first audio signal.

10. The method of claim 9, wherein the obtaining of the mask corresponding to the user based on the registered audio information associated with the user and the feature of the first audio signal comprises:
obtaining the mask corresponding to the user, based on the registered audio information associated with the user, the feature of the first audio signal, and a feature of the BC signal, using a fourth AI model.

11. The method of claim 9, wherein the obtaining of the feature of the first audio signal comprises:
performing a feature extraction on the first audio signal to obtain a first frequency domain feature;
performing frequency band dividing on the first frequency domain feature to obtain a plurality of sub-frequency domain features corresponding to a plurality of sub-bands of the first audio signal; and
performing feature encoding on the plurality of sub-frequency domain features to obtain a plurality of first features corresponding to the plurality of the sub-bands of the first audio signal as the feature of the first audio signal.

12. The method of claim 9, wherein the extracting of the second audio signal based on the mask and the feature of the first audio signal comprises:
obtaining a plurality of second features corresponding to a plurality of sub-bands of the second audio signal based on a plurality of sub-masks in the mask corresponding to the plurality of sub-bands of the first audio signal and the plurality of first features;
performing feature decoding on the plurality of second features to obtain a plurality of second frequency domain features corresponding to the plurality of sub-bands of the second audio signal;
performing frequency band merging on the plurality of second frequency domain features; and
obtaining the second audio signal based on the merged plurality of second frequency domain features.

13. The method of claim 1, wherein the processing of the at least one from among the extracted second audio signal and the portion of the first audio signal comprises at least one of:
amplifying the at least one from among the extracted second audio signal and the portion of the first audio signal, and
mixing the extracted second audio signal with a third audio signal.

14. The method of claim 13, wherein the amplifying of the at least one from among the extracted second audio signal and the portion of the first audio signal comprises:
amplifying the extracted second audio signal and the portion of the first audio signal in different proportions.

15. An electronic apparatus, the apparatus comprising:
a memory configured to store instructions; and
at least one processor configured to execute the instructions to:
determine registered audio information associated with a user based on a bone conduction (BC) signal;
extract a second audio signal corresponding to the user from a first audio signal based on the registered audio information associated with the user; and
process the at least one from among the extracted second audio signal and a portion of the first audio signal which does not contain the second audio signal.

16. The electronic apparatus of claim 15, wherein the at least one processor further configured to execute the instructions to:
evaluate a quality of a previously-extracted second audio signal based on content of the previously-extracted second audio signal and the BC signal; and
determine the registered audio information associated with the user based on the quality of the previously-extracted second audio signal.

17. The electronic apparatus of claim 16, wherein the at least one processor further configured to execute the instructions to:
classify the previously-extracted second audio signal and the BC signal based on a voice feature;
determine a matching probability between a category of the previously-extracted second audio signal and a category of the BC signal; and
evaluate the quality of the previously-extracted second audio signal based on the matching probability.

18. The electronic apparatus of claim 16, wherein the at least one processor further configured to execute the instructions to:
determine whether to update the registered audio information associated with the user based on the quality of the previously-extracted second audio signal;
determine a feature change trend of BC registration information; and
predict registered audio information from an air conduction (AC) signal as the registered audio information associated with the user based on the feature change trend of the BC registration information.

19. The electronic apparatus of claim 15, wherein the at least one processor further configured to execute the instructions to:
obtain a feature of the first audio signal;
obtain a mask corresponding to the user based on the registered audio information associated with the user and the feature of the first audio signal; and
extract the second audio signal based on the mask and the feature of the first audio signal.

20. A non-transitory computer-readable storage medium storing instructions which when executed by at least one processor, cause the at least one processor to:
determine registered audio information associated with a user based on a bone conduction (BC) signal;
extract a second audio signal corresponding to the user from a first audio signal based on the registered audio information associated with the user; and
process the at least one from among the extracted second audio signal and a portion of the first audio signal which does not contain the second audio signal.
